(19) United States
(12) Patent Application Publication
(10) Pub. No.: US 2016/0084295 A1
(43) Pub. Date: Mar. 24, 2016

(54) METHOD OF MANUFACTURING A CRANKSHAFT FROM A HIGH SHRINK METAL ALLOY

(71) Applicant: GM GLOBAL TECHNOLOGY OPERATIONS LLC, Detroit, MI (US)

(72) Inventors: Dale Edward Murrish, Troy, MI (US); Edward R. Romblom, DeWitt, MI (US); Brian J. McClory, Royal Oak, MI (US); Ronald M. Tkac, Brighton, MI (US); Donald J. Perella, Troy, MI (US)

(21) Appl. No.: 14/492,714

(22) Filed: Sep. 22, 2014

(51) Int. Cl. F16C 3/08; B22C 9/22; F16F 15/28; B22D 25/02; C22C 38/00; B22C 9/10; B22D 29/00

(52) U.S. Cl. CPC F16C 3/08; B22C 9/10; B22C 9/22; B22D 29/001; B22D 25/02; C22C 38/00; F16F 15/283

(57) ABSTRACT

A crankshaft includes a pin bearing journal, and a counterweight. The pin bearing journal defines a hollow pin core. The hollow pin core includes a first pin core section and a second pin core section, and an enlarged central section disposed between the first pin core section and the second pin core section. The first and second pin core sections each define a cross section having a first and second cross sectional area respectively, and the enlarged central section defines a third cross section defining a third cross sectional area, with the third cross sectional area larger than the first and second cross sectional areas. An isolation window extends through the counterweight. The crankshaft is cast from a high shrink steel alloy having a shrinkage factor equal to or greater than 1%. The enlarged central section and the isolation window improve the castability of the high shrink steel alloy.

### TECHNICAL FIELD

The disclosure generally relates to a method of manufacturing a crankshaft from a high shrink steel alloy.

### BACKGROUND

An engine's crankshaft converts reciprocating linear movement of a piston into rotational movement about a crank axis to provide torque to propel a vehicle, such as but not limited to a train, a boat, a plane, or an automobile. Crankshafts are a vital part of an engine, and are a starting point of engine design. Crankshaft design affects the overall packaging of the engine, and thereby the total mass of the engine. Accordingly, minimizing the size and/or mass of the crankshaft reduces the size and mass of the engine, which has a compounding effect on the overall size, mass and fuel economy of the vehicle.

The crankshaft includes at least one crank pin journal that is offset from the crank axis, to which a reciprocating piston is attached via a connecting rod. Force applied from the piston to the crankshaft through the offset connection therebetween generates torque in the crankshaft, which rotates the crankshaft about the crank axis. The crankshaft further includes at least one main bearing journal disposed concentrically about the crank axis. The crankshaft is secured to an engine block at the main bearing journals. A bearing is disposed about the main bearing journal, between the crankshaft and the engine block.

The crankshaft is typically formed or manufactured by a casting process, such as but not limited to a green sand casting process or a shell mold casting process, which uses cast iron to form the crankshaft. Alternatively, the crankshaft may be forged from a steel alloy. Steel is stronger than cast iron, and therefore is a more desirable material to use for crankshafts. However, the forging process is more costly than the casting process. Most steel alloys exhibit a high shrinkage while cooling, and do not cast well, because the shrinkage that occurs while the cast product cools forms voids in the final cast product. This weakens the final cast product and makes it unsuitable for use in an engine.

### SUMMARY

A method of manufacturing a crankshaft is provided. The method includes positioning a casting core within a cavity of a mold having a first half and a second half forming an exterior shape of the crankshaft. The exterior shape of the crankshaft includes a pin bearing journal, a main bearing journal, a first crank arm and a second crank arm supporting the pin bearing journal, and a counterweight extending radially outward from the second crank arm relative to a crank axis. The crankshaft is cast by introducing a molten metal alloy into the cavity to form the crankshaft. The molten metal alloy flows into the cavity and around the casting core to form a hollow pin core extending through the first crank arm, the pin bearing journal and the second crank arm, a hollow main core extending through the second crank arm and into the main bearing journal, and an isolation window extending at least partially through the counterweight. The isolation window is disposed radially between an outer radial edge of the counterweight and the second crank arm. The hollow pin core is shaped to minimize a cross sectional thickness of the metal alloy between a radially inner surface of the hollow pin core and a bearing surface of the pin bearing journal. The molten metal alloy is cooled in the cavity around the casting core to solidify the metal alloy forming the crankshaft. The casting core is removed from the cast crankshaft. The metal alloy is a high shrink alloy having a shrinkage factor equal to or greater than 1% during cooling of the molten metal alloy.

A crankshaft for an engine is also provided. The crankshaft includes, a pin bearing journal, a main bearing journal, a first crank arm supporting the pin bearing journal, a second crank arm supporting the pin bearing journal and connecting the pin bearing journal and the main bearing journal, and a counterweight extending radially outward from the second crank arm relative to a crank axis. The first crank arm, the pin bearing journal, and the second crank arm cooperate to define a hollow pin core extending along the crank axis between a first axial side surface of the first crank arm and a second axial side surface of the second crank arm respectively. The hollow pin core includes a first pin core section extending substantially through the first crank arm, a second pin core section extending substantially through the second crank arm, and an enlarged central section disposed between the first pin core section and the second pin core section. The crankshaft is cast from a high shrink steel alloy having a shrinkage factor equal to or greater than 1%.

Accordingly, the enlarged central section of the hollow pin core reduces the cross sectional thickness of the pin bearing journal perpendicular to the crank axis, between the radially inner surface of the hollow pin core and the bearing surface of the pin bearing journal. Reducing the cross sectional thickness in this region of the pin bearing journal lowers the amount of the steel alloy in this region, which improves castability of the high shrink steel alloy by minimizing the voids that form in the steel alloy as the steel alloy shrinks during cooling. Additionally, minimizing the cross sectional thickness of the pin bearing journal in this region reduces the rotating inertia and the rotating mass of the crankshaft. Similarly, forming the isolation window in the counterweight reduces the amount of the steel alloy in the counterweight, which improves castability by minimizing the voids that form in the steel alloy as the steel alloy shrinks during cooling.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic, partial perspective view of a crankshaft.

FIG. 2 is a schematic, partial cross sectional view of the crankshaft cut on a crank axis of the crankshaft.

FIG. 3 is a schematic cross sectional view of a first pin core section of a hollow pin core of the crankshaft, cut perpendicular to the crank axis.

FIG. 4 is a schematic cross sectional view of an enlarged central section of the hollow pin core of the crankshaft, cut perpendicular to the crank axis.

FIG. 5 is a schematic cross sectional view of a counterweight of the crankshaft, cut perpendicular to the crank axis.

FIG. 6 is a schematic, partial cross sectional view of a casting core used to form the crankshaft in a casting process.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

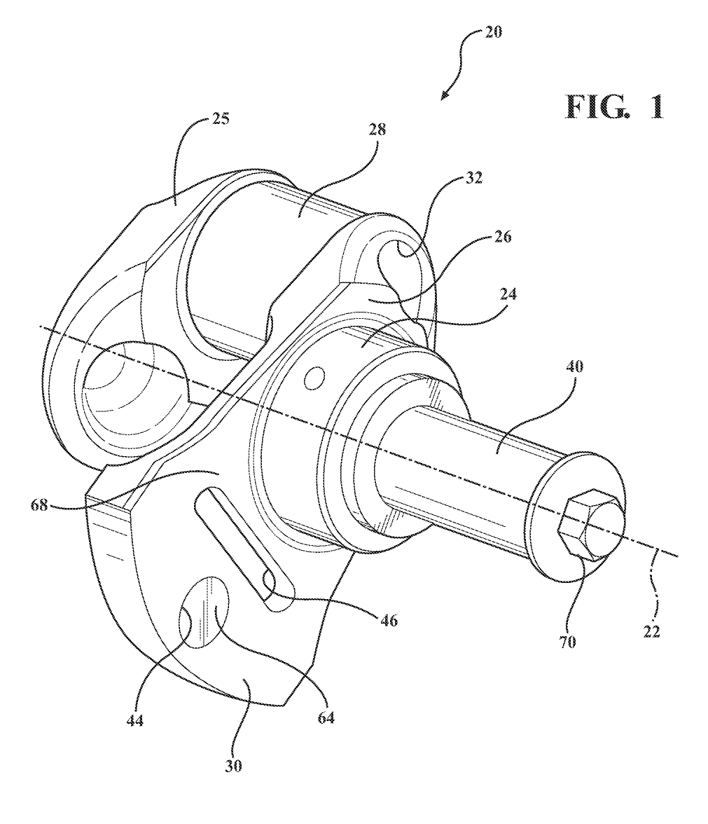

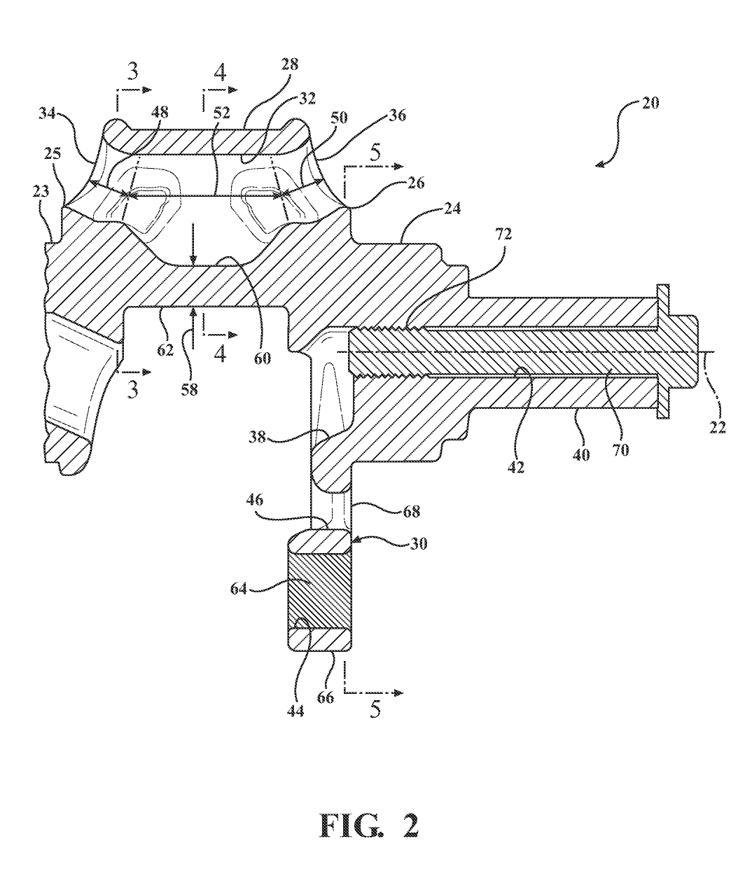

Referring to the Figures, wherein like numerals indicate like parts throughout the several views, a crankshaft is generally shown at 20. The crankshaft 20 is cast from a high shrink metal alloy, such as but not limited to a high shrink steel alloy. Referring to the Figures, the crankshaft 20 may be configured for an engine, such as but not limited to a gasoline engine or a diesel engine, a compressor, or some other similar device. Referring to FIGS. 1 and 2, the crankshaft 20 extends along a crank axis 22, and defines a main bearing journal 24, at least one crank arm, a pin bearing journal 28, and a counterweight 30. As shown, the at least one crank arm includes a first crank arm 25, a second crank arm 26. Additionally, it should be appreciated that the term “crank arm” should be construed herein as including either a “crank arm” or a “flying arm”. As used herein, the term “crank arm” is used to describe an arm of the crankshaft 20 that connects a main bearing journal and a pin bearing journal, and the term “flying arm” is used to describe an arm of the crankshaft that connects one pin bearing journal to another pin bearing journal. The Figures show only a portion of the crankshaft 20. As such, the Figures only identify one main bearing journal 24, the first crank arm 25 and the second crank arm 26, one pin bearing journal 28, and one counterweight 30. However, it should be appreciated that the teachings of the disclosure may be applied to any style of crankshaft 20 having any number of main bearing journals, any number of crank arms, any number of pin bearing journals, and any number of counterweights.

The main bearing journal 24 is disposed concentrically about the crank axis 22. The pin bearing journal 28 is laterally offset from the crank axis 22, and is attached to the main bearing journal 24 by the second crank arm 26. The first crank arm 25 supports that pin bearing journal 28, and attaches the pin bearing journal 28 to another or second main bearing journal 23. The second crank arm 26 extends between and connects the main bearing journal 24 to the pin bearing journal 28. The counterweight 30 extends radially outward and away from the second crank arm 26 relative to the crank axis 22. The main bearing journal 24 supports a bearing (not shown) thereabout, and provides an attachment location for attaching the crankshaft 20 to an engine block (not shown). The pin bearing journal 28 supports a bearing (not shown) thereabout, and provides the attachment point to which a connecting rod (not shown) attaches a piston (not shown) to the crankshaft 20. The counterweight 30 offsets the reciprocating mass of the piston, piston rings, piston pin and retaining clips, a small end of the connecting rod, the rotating mass of a large end of the connecting rod and bearings, and the rotating mass of the crankshaft 20 itself (the pin bearing journal 28 and the first and second crank arms 25, 26). The main bearing journal 24 is on the crankshaft 20 axis and does not need to be balanced by the counterweight 30. The counterweight 30 reduces the forces acting on the main bearing journal 24 and thereby improves the durability of the bearings. The counterweight 30 balances the rotation of the crankshaft 20 about the crank axis 22 to reduce vibration therein.

Referring to FIG. 2, the crankshaft 20 includes a plurality of different hollow core sections. Specifically, the first crank arm 25, the second crank arm 26, and the pin bearing journal 28 cooperate to define a hollow pin core 32, which extends along the crank axis 22 between a first axial side surface 34 of the first crank arm 25, and a second axial side surface 36 of the second crank arm 26. A hollow main core 38 extends through the second crank arm 26, and into a center of the main bearing journal 24 along the crank axis 22. The hollow main core 38 may or may not extend completely through a center of the main bearing journal 24. A crank nose 40 of the crankshaft 20 defines a hollow nose core 42, which extends axially along and is concentric with the crank axis 22. As shown, the hollow nose core 42 is open to and connected with the hollow main core 38. However, in other embodiments, the hollow nose core 42 may not be connected to the hollow main core 38, and may be separated from the hollow main core 38 by a wall (not shown). The counterweight 30 defines a hollow counterweight core 44, which extends through the counterweight 30, along the crank axis 22. The counterweight 30 further defines an isolation window 46, which at least partially extends through a web portion 68 of the counterweight 30. The hollow pin core 32, the hollow main core 38, the hollow counterweight core 44, and the isolation window 46 may, but do not necessarily extend parallel to the crank axis 22. Accordingly, the hollow pin core 32, the hollow main core 38, the hollow counterweight core 44, and the isolation window 46 may extend parallel with the crank axis, or may be angled toward or away from the crank axis slightly. The hollow pin core 32, the hollow main core 38, the hollow counterweight core 44, and the isolation window 46 of the crankshaft 20 reduce the volume of metal used to form the crankshaft 20, thereby making the crankshaft 20 more castable. Since the hollow pin core 32 is laterally offset from the crank axis 22, the mass of the counterweight 30 may also be reduced a corresponding amount, thereby further reducing the overall weight of the crankshaft 20.

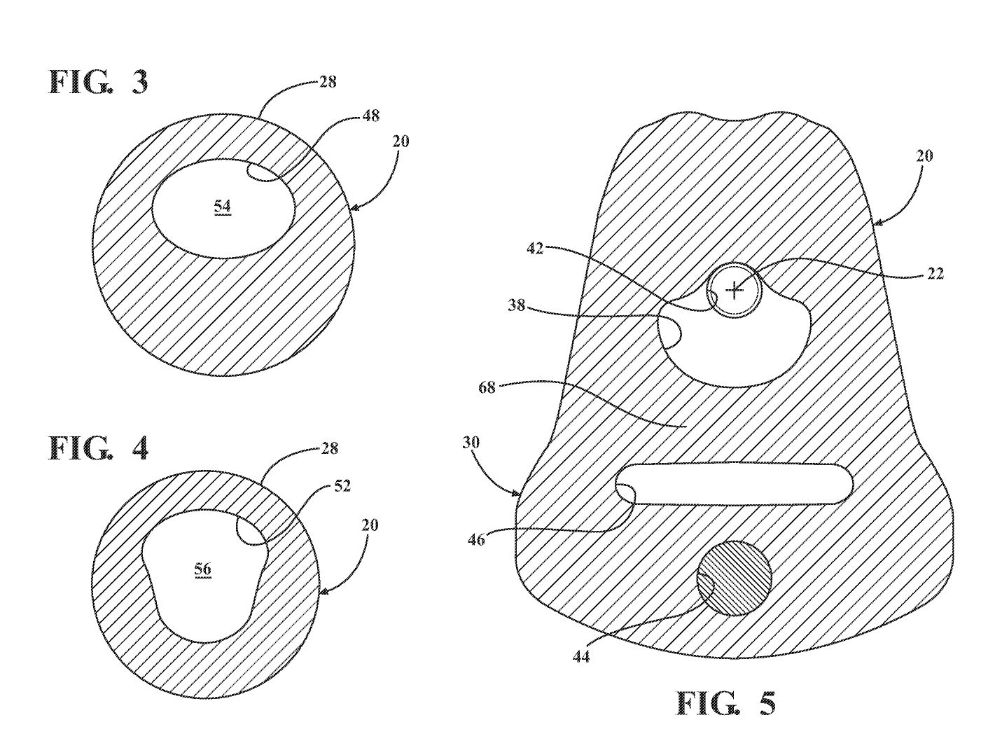

Referring to FIGS. 2 through 4, the hollow pin core 32 includes a first pin core section 48, a second pin core section 50, and an enlarged central section 52. The first pin core section 48 extends substantially through the first crank arm 25. The second pin core section 50 extends substantially through the second crank arm 26. The enlarged central section 52 extends substantially through the pin bearing journal 28. The enlarged central section 52 is disposed between the first pin core section 48 and the second pin core section 50, at an approximate midsection of the pin bearing journal 28. As shown in FIG. 3, the first pin core section 48 defines a first cross section substantially perpendicular to the crank axis 22. The second pin core section 50 defines a second cross section substantially perpendicular to the crank axis 22. Preferably, the first cross section and the second cross section of the first pin core section 48 and the second pin core section 50 each define a substantially elliptical shape having a first cross sectional area and a second cross sectional area respectively. FIG. 3 shows the first cross section of the first pin core section 48, having the first cross sectional area 54. Preferably, the second cross section of the second pin core section 50 is substantially identical to the first cross section of the first pin core section 48 shown in FIG. 3. However, the second cross section and the second cross sectional area of the second pin core section 50 may differ from that of the first pin core section 48 shown in FIG. 3. The enlarged central section 52 defines a third cross section perpendicular to the crank axis 22 defining a third cross sectional area 56. The third cross sectional area 56 is larger than the first cross sectional area 54, and the second cross sectional area (not specifically shown but preferably equal to the first cross sectional area 54). The third cross sectional shape of the enlarged central section 52 may be loosely described as egg shaped, i.e., a partial elliptical shape having a protrusion or oblong portion extending radially toward the crank axis 22, relative to the first pin core section 48 and the second pin core section 50. The enlarged central section 52 of the hollow pin core 32 minimizes or reduces a cross sectional thickness 58 of the pin bearing journal 28 between a radially inner surface 60 all of the hollow pin core 32 and a bearing surface 62 of the pin bearing journal 28. Reducing the cross sectional thickness 58 of the pin bearing journal 28 in this region reduces the amount of the metal alloy in this region used to form the crankshaft 20, which improves castability of the crankshaft 20 as will be described in greater detail below.

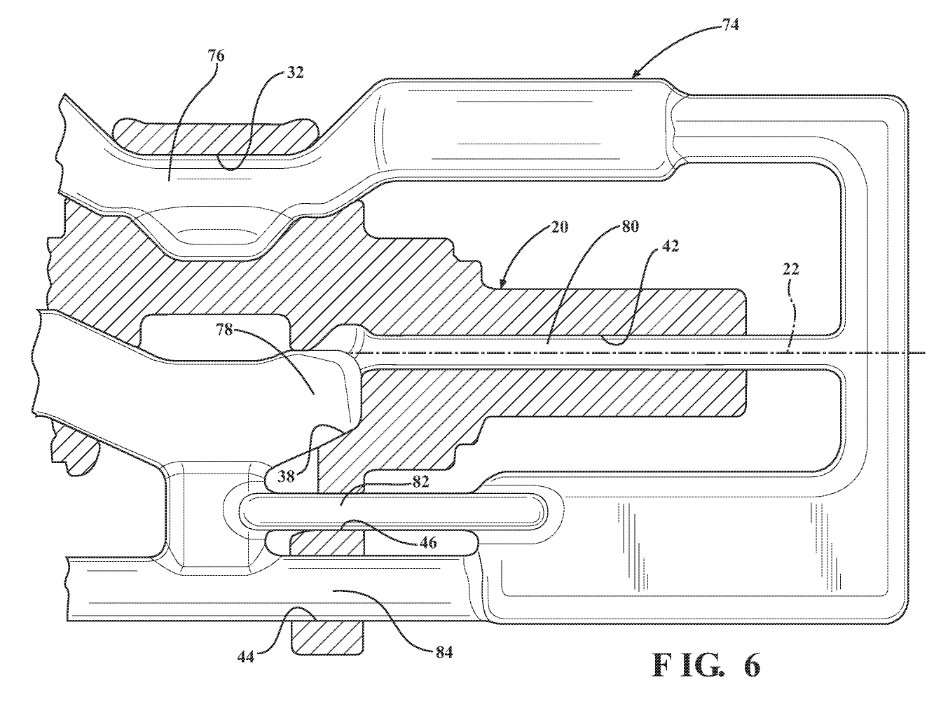

Referring to FIGS. 2 and 5, the counterweight 30 may include an insert 64 disposed within the hollow counterweight core 44. It should be appreciated that the insert 64, and therefore the hollow counterweight core 44, are optional, and may not be required for all applications. The insert 64 is disposed adjacent a radially outer surface 66 of the counterweight 30 relative to the crank axis 22. Preferably, the insert 64 is formed from a material e.g., a heavy metal, having a greater density than the metal alloy used to form the crankshaft 20.

As noted above, and as best shown in FIGS. 2 and 5, the counterweight 30 may be formed to include the isolation window 46, which extends axially along the crank axis 22, at least partially through a web portion 68 of the counterweight 30. Preferably, the isolation window 46 is disposed radially between the hollow counterweight core 44 (if the crankshaft 20 is equipped with the insert 64) and the hollow main core 38, relative to the crank axis 22. The isolation window 46 may extend completely through the web portion 68 of the counterweight 30, such as shown in the Figures. Alternatively, the isolation window 46 may only partially extend into the web portion 68 of the counterweight 30, thereby forming a blind bore or recess.

Referring to FIG. 2, and as noted above, the crank nose 40 defines the hollow nose core 42. The hollow nose core 42 is concentric with and extends along the crank axis 22. A damper bolt 70 is disposed within the hollow nose core 42, and is disposed in threaded engagement 72 with the crankshaft 20 to secure the damper bolt 70 to the crankshaft 20 as is known in the art. If the crankshaft 20 is designed for use in a dry sump engine, such as shown, then the threads of the damper bolt 70 may be sealed with a thread patch, and the hollow nose core 42 and the hollow main core 38 may be connected to reduce the number of casting cores 74 required to form the crankshaft 20. However, if the crankshaft 20 is designed for use in a wet sump engine, then the hollow nose core 42 and the hollow main core 38 should be separated by a solid wall.

Preferably, the crankshaft 20 is formed through a casting process, such as but not limited to a green sand casting process or a shell mold casting process, as generally understood. As noted above, the crankshaft 20 is cast from a high shrink metal alloy. The high shrink metal alloy is defined as a metal alloy having a shrinkage factor equal to or greater than 1% during the cooling stage of the casting process. For example, the high shrink metal alloy may include, but is not limited to a high shrink steel alloy, such as but not limited to alloyed steel with AISI Series designation 1300, 4100, 8100 or 8600. Because the high shrink metal alloy shrinks during the cooling stage of the casting process, the metal alloy may form voids within the crankshaft 20. It has been discovered that reducing the mass or volume of the high shrink metal alloy in critical areas or regions of the crankshaft 20 improves castability of the high shrink metal alloy, and enables the use of the high shrink metal alloy to cast the crankshaft 20. For this reason, the hollow pin core 32 is formed with the enlarged central section 52, and the counterweight 30 is formed with the isolation window 46. The enlarged central section 52 and the isolation window 46 reduce the volume of metal alloy in these respective regions, which enables the use of the metal alloy by improving the castability of the high shrink metal alloy in these regions, providing a stronger and more durable crankshaft 20 when cast from the metal alloy.

Manufacturing or casting the crankshaft 20 includes forming a first half and a second half of a mold to define a cavity therebetween. The cavity forms an exterior shape of the crankshaft 20. The first half may be referred to as a cope or upper half, and the second half may be referred to as a drag or lower half. As is generally understood, the first half and the second half of the mold may be formed by pressing a template defining half of the desired finished exterior shape of the crankshaft 20 into a form of green sand or some other suitable medium, thereby leaving a negative imprint of that half of the crankshaft 20 therein. Upon combining the first half and the second half together to form the mold, the negative imprints therein adjoin to complete the cavity and define the exterior shape of the crankshaft 20. The exterior shape of the crankshaft 20 includes but is not limited to the pin bearing journal 28, the first crank arm 25, the second crank arm 26, the main bearing journal 24, the counterweight 30, and the crank nose 40.

Referring to FIG. 6, a casting core 74 is formed to define portions of the crankshaft 20, including the hollow pin core 32, the hollow main core 38, the hollow counterweight core 44, the isolation window 46, and the hollow nose core 42. The casting core 74 may be a single core, or may include more than one core. The casting core 74 may be formed to include a pin core forming section 76, a main core forming section 78, a nose core forming section 80, a counterweight core forming section 84, and a window forming section 82. It should be appreciated that the casting core 74 forms the shape of the hollow sections of the crankshaft 20. Accordingly, the shape of the different sections of the casting core 74 is identical to the respective hollow sections of the crankshaft 20. For example, the exterior shape of the pin core forming section 76 is identical to the interior shape of the hollow pin core 32. Therefore, it should be appreciated that the various forming sections of the casting core 74 are shaped to define the desired hollow sections of the crankshaft 20. The pin core forming section 76 is shaped to form the hollow pin core 32 such that the hollow pin core 32 includes the first pin core section 48 extending through the first crank arm 25, the second pin core section 50 extending through the second crank arm 26, and the enlarged central section 52 disposed between the first pin core section 48 and the second pin core section 50, and extending through the pin bearing journal 28. The main core forming section 78 is shaped to form the hollow main core 38 extending through the second crank arm 26 and into the main bearing journal 24. The window forming section 82 is shaped to form the isolation window 46 partially into or through the counterweight 30. The counterweight 30 forming section is shaped to form the hollow counterweight core 44 extending through the counterweight 30 along the crank axis 22. The nose core forming section 80 is shaped to form the hollow nose core 42 in the crank nose 40 of the crankshaft 20. Once the casting core 74 is properly formed, the casting core 74 is positioned within the cavity between the first half and the second half of the mold.

Once the casting core 74 is positioned within the cavity and the first half of the mold is secured relative to the second half of the mold, the molten metal alloy is introduced into the cavity to form the crankshaft 20. As described above, the metal alloy is a high shrink metal alloy, and is preferably a high shrink steel alloy. The molten metal alloy flows into the cavity and around the casting core 74 to simultaneously form each of the hollow sections of the crankshaft 20. After the molten metal alloy is introduced, e.g., poured, into the cavity, the molten metal alloy is allowed to cool and solidify. Once solidified, the first half and the second half of the mold may be separated, thereby exposing the cast crankshaft 20 and the casting core 74. The casting core 74 may then be removed from the crankshaft 20 by breaking, chipping and/or flushing away the material forming the casting core 74, thereby leaving the crankshaft 20 with the hollow sections formed therein.

If the crankshaft 20 is to be equipped with an insert 64, then the insert 64 may be positioned within the hollow counterweight core 44 after the casting core 74 is removed.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of manufacturing a crankshaft, the method comprising:
positioning a casting core within a cavity of a mold having a first half and a second half forming an exterior shape of the crankshaft, wherein the exterior shape of the crankshaft includes a pin bearing journal, a main bearing journal, a first crank arm and a second crank arm supporting the pin bearing journal, and a counterweight extending radially outward from the second crank arm relative to a crank axis;
casting the crankshaft by introducing a molten metal alloy into the cavity to form the crankshaft, wherein the molten metal alloy flows into the cavity and around the casting core to form a hollow pin core extending through the first crank arm, the pin bearing journal and the second crank arm, a hollow main core extending through the second crank arm and into the main bearing journal, and an isolation window extending at least partially through the counterweight, wherein the isolation window is disposed radially between an outer radial edge of the counterweight and the second crank arm;
wherein the hollow pin core is shaped to include a first pin core section extending through the first crank arm, a second pin core section extending through the second crank arm, and an enlarged central section extending through the pin bearing journal between the first pin core section and the second pin core section, with the enlarged central section sized larger than the first pin core section and the second pin core section respectively to minimize a cross sectional thickness of the metal alloy between a radially inner surface of the hollow pin core and a bearing surface of the pin bearing journal, without interfering with the main bearing journal;
cooling the molten metal alloy in the cavity around the casting core to solidify the metal alloy forming the crankshaft; and
removing the casting core from the cast crankshaft;
wherein the metal alloy is a high shrink alloy having a shrinkage factor equal to or greater than 1% during cooling of the molten metal alloy.

2. The method set forth in claim 1 wherein the high shrink alloy is a steel alloy.

3. The method set forth in claim 1 further comprising forming the casting core prior to positioning the casting core in the cavity of the mold.

4. The method set forth in claim 3 wherein forming the casting core is further defined as forming the casting core to include a pin core forming section, wherein the pin core forming section is shaped to form the hollow pin core such that the hollow pin core includes the first pin core section extending substantially through the first crank arm along the crank axis, the second pin core section extending substantially through the second crank arm along the crank axis, and the enlarged central section disposed between the first pin core section and the second pin core section, wherein the first pin core section defines a first cross section perpendicular to the crank axis that includes a first cross sectional area, the second pin core section defines a second cross section perpendicular to the crank axis that includes a second cross sectional area, wherein the enlarged central section defines a third cross section perpendicular to the crank axis that includes a third cross sectional area, and wherein the first cross sectional area of the first pin core section and the second cross sectional area of the second pin core section are each less than the third cross sectional area of the enlarged central section.

5. The method set forth in claim 4 wherein the enlarged central section includes a protrusion extending radially inward toward the crank axis to minimize a cross sectional thickness of the steel alloy between a radially inner surface of the hollow pin core and a bearing surface of the pin bearing journal.

6. The method set forth in claim 4 wherein forming the casting core is further defined as forming the casting core to include a window forming section, wherein the window forming section is shaped to form the isolation window in the counterweight.

7. The method set forth in claim 6 wherein forming the casting core is further defined as forming the casting core to include a counterweight core forming section, wherein the counterweight core forming section is shaped to form a counterweight core extending through the counterweight along the crank axis.

8. The method set forth in claim 6 further comprising positioning an insert within the counterweight core, wherein the insert includes a metal having a density greater than the metal alloy.

9. The method set forth in claim 4 wherein the first cross section of the first pin core section and the second cross section of the second pin core section each define an elliptical shape.

10. The method set forth in claim 3 wherein forming the casting core is further defined as forming the casting core to include a nose core forming section, wherein the nose core forming section is shaped to form a nose core in a crank nose of the crankshaft, such that the nose core extends through the crank nose along the crank axis, and is connected to the hollow main core.

11. A method of manufacturing a crankshaft, the method comprising:
forming a casting core to include a pin core forming section, a window forming section, a nose core forming section, a main core forming section, and a counterweight core forming section;
positioning the casting core within a cavity of a mold having a first half and a second half forming an exterior shape of the crankshaft, wherein the exterior shape of the crankshaft includes a pin bearing journal, a main bearing journal, a first crank arm and a second crank arm supporting the pin bearing journal, and a counterweight extending radially outward from the second crank arm relative to a crank axis;
casting the crankshaft by introducing a molten metal alloy into the cavity to form the crankshaft, wherein the molten metal alloy flows into the cavity and around the casting core to form a hollow pin core extending through the first crank arm, the pin bearing journal, and the second crank arm, a hollow main core extending through the second crank arm and into the main bearing journal, and an isolation window extending at least partially through the counterweight, wherein the isolation window is disposed radially between an outer radial edge of the counterweight and the second crank arm; and
cooling the molten metal alloy in the cavity around the casting core to solidify the metal alloy forming the crankshaft; and
removing the casting core from the cast crankshaft;
wherein the metal alloy is a high shrink steel alloy having a shrinkage factor equal to or greater than 1% during cooling of the molten steel alloy.

12. The method set forth in claim 11 wherein:
the pin core forming section is shaped to form the hollow pin core such that the hollow pin core includes a first pin core section extending substantially through the first crank arm along the crank axis, a second pin core section extending substantially through the second crank arm along the crank axis, and an enlarged central section disposed between the first pin core section and the second pin core section, wherein with the first pin core section defines a first cross section perpendicular to the crank axis that includes a first cross sectional area, the second pin core section defines a second cross section perpendicular to the crank axis that includes a second cross sectional area, and wherein the enlarged central section defines a third cross section perpendicular to the crank axis that includes a third cross sectional area, wherein the first cross sectional area of the first pin core section and the second cross sectional area of the second pin core section are each less than the third cross sectional area of the enlarged central section;
the main core forming section is shaped to form the hollow main core through the second crank arm and into a central portion of the main bearing journal, along the crank axis;
the counterweight core forming section is shaped to form a counterweight core extending through the counterweight along the crank axis;
the window forming section is shaped to form the isolation window in the counterweight, radially between the counterweight core and the second crank arm relative to the crank axis; and
the nose core forming section is shaped to form a nose core in a crank nose of the crankshaft, such that the nose core extends through a crank nose along the crank axis, and is connected to the hollow main core.

13. A crankshaft for an engine, the crankshaft comprising:
a pin bearing journal;
a main bearing journal;
a first crank arm supporting the pin bearing journal;
a second crank arm supporting the pin bearing journal and connecting the pin bearing journal and the main bearing journal; and
a counterweight extending radially outward from the second crank arm relative to a crank axis;
wherein the first crank arm, the pin bearing journal, and the second crank arm cooperate to define a hollow pin core extending along the crank axis between a first axial side surface of the first crank arm and a second axial side surface of the second crank arm;
wherein the hollow pin core includes a first pin core section extending substantially through the first crank arm, a second pin core section extending substantially through the second crank arm, and an enlarged central section extending through the pin bearing journal between the first pin core section and the second pin core section, with the enlarged central section sized larger than the first pin core section and the second pin core section respectively to minimize a cross sectional thickness of the metal alloy between a radially inner surface of the hollow pin core and a bearing surface of the pin bearing journal, without interfering with the main bearing journal; and
wherein the crankshaft is cast from a high shrink metal alloy having a shrinkage factor equal to or greater than 1%.

14. The crankshaft as set forth in claim 13 wherein the first pin core section defines a first cross section perpendicular to the crank axis having a substantially elliptical shape defining a first cross sectional area, the second pin core section defines a second cross section perpendicular to the crank axis having a substantially elliptical shape defining a second cross sectional area, and wherein the enlarged central section defines a cross section perpendicular to the crank axis defining a third cross sectional area, with the third cross sectional area larger than each of the first cross sectional area and the second cross sectional area.

15. The crankshaft as set forth in claim 14 wherein the enlarged central section includes a protrusion extending radially inward toward the crank axis, relative to the first pin core section and the second pin core section, to minimize a cross sectional thickness of the pin bearing journal between a radially inner wall of the hollow pin core and a bearing surface of the pin bearing journal.

16. The crankshaft as set forth in claim 13 further comprising a hollow main core extending through the second crank arm and into a center of the main bearing journal along the crank axis.

17. The crankshaft as set forth in claim 13 wherein the counterweight includes an isolation window extending axially along the crank axis, at least partially through a web portion of the counterweight.

18. The crankshaft as set forth in claim 17 wherein the counterweight includes an insert disposed within a counterweight core adjacent a radially outer surface of the counterweight relative to the crank axis.

19. The crankshaft as set forth in claim 16 further comprising a crank nose defining a nose core concentric with and extending along the crank axis

20. The crankshaft as set forth in claim 19 wherein the nose core and the hollow main core are connected.
